(19) United States
(12) Patent Application Publication
(10) Pub. No.: US 2020/0380526 A1
(43) Pub. Date: Dec. 3, 2020

(54) METHODS AND DEVICES FOR BIOMETRIC AUTHORISATION

(71) Applicants: VERIDAS DIGITAL AUTHENTICATION SOLUTIONS, S.L., Tajonar (ES); DAS-NANO, S.L., Tajonar (ES)

(72) Inventors: Miguel Ángel SÁNCHEZ YOLDI, Tajonar (ES); Carlos ARANA REMIREZ, Tajonar (ES); Miguel ISLA URTASUN, Tajonar (ES); Francisco Julián ZAMORA MARTÍNEZ, Tajonar (ES); Eduardo AZANZA LADRÓN, Tajonar (ES)

(73) Assignees: VERIDAS DIGITAL AUTHENTICATION SOLUTIONS, S.L., Tajonar (ES); DAS-NANO, S.L., Tajonar (ES)

(21) Appl. No.: 16/960,509

(22) PCT Filed: Apr. 11, 2018
(86) PCT No.: PCT/EP2018/059278

§ 371 Date: Jul. 7, 2020

(30) Foreign Application Priority Data
Jan. 9, 2018 (EP) 18382006.7

(51) Int. Cl. G06Q 20/40; G06Q 20/32; G06Q 30/02

(52) U.S. Cl. CPC G06Q 20/40145; G06Q 30/0212; G06Q 20/3226; G06Q 20/3223

(57) ABSTRACT

Methods and devices for performing user authorisations using biometric features are disclosed. User identifiers and biometric features of the users are registered in an identification server. Users are identified by their user identifiers, the users being in communication range with an authorisation module. A shortlist of users is generated based identified user identifiers. Biometric features of the users are captured at the authorisation module. The biometric features presented are compared with biometric features stored in the identification server to generate a match probability. Users are validated if the match probability exceeds a threshold. User authorisation is performed when the users are identified and validated.

This application claims the benefit of European Patent Application EP18382006.7 filed Jan. 9, 2018.

The present disclosure relates to biometrics and more specifically user authorisation using biometric features.

### BACKGROUND

Nowadays, digital information has become a key member of society, as it reaches every aspect of routine at work, at leisure time, at the administration and at practically every task performed daily. This fact has been particularly important thanks to the development of internet-enabled portable devices and the increase of their computing power, which has provoked them to be used in the same manner as computers.

Under this context, using the mobile phone to perform sensitive operations in terms of accessed information, the operation itself and confidentiality has also become more common among the users, it becoming a problem for developers as well, because information handling and processing in such situations emerge as also a sensitive matter.

For example, the Directive (EU) 2015/2366 on payment services in the internal market, commonly known as PSD2, introduced a new security requirement that shall be complied by payment services provided within the European Union, especially when the operations are performed online. This measure is called “strong customer authentication” and implies that an authentication is based on the use of two or more elements categorised as knowledge (something only the user knows), possession (something only the user possesses) and inherence (something the user is) that are independent, in that the breach of one does not compromise the reliability of the others, and is designed in such way as to protect the confidentiality of the authentication data.

Therefore, a convention has been stablished for information access protocols as a combination of at least two from the following three factors:
Checking “something that the user knows”: This definition comprises the traditional password method (among others), in which some sort of verification related with knowledge of the user is verified.
Checking “something that the user has”: This definition comprises verifications related with possessions of the user. One example of such security measure would be checking if the mobile phone being used for information access is the one owned by the user.
Checking “something that the user is”: This definition comprises verification of biological feature measures of the user, the so-called biometry. One example of such security measure would be assessing the user's face.

Furthermore, biometric authorisation is a key factor in terms of user experience and interaction simplicity. Thus, biometry may be used as a fixed security factor in combination with one or more of the other two factors.

### SUMMARY

This proposal presents a biometric user authorisation method and system.

In a first aspect, a method of performing a user authorisation of a user using biometric features is disclosed. The method comprises registering a user identifier and one or more biometric features of the user in an identification server; identifying the user by the user identifier, the user being in communication range with an authorisation module; generating a shortlist of users based on user identifiers identified; capturing the one or more biometric features of the user at the authorisation module; comparing the one or more biometric features presented with biometric features stored in the identification server to generate a match probability; validating the user if the match probability exceeds a threshold; and performing the user authorisation when the user is identified and validated.

By generating a shortlist of users in communication range with the authorisation module, the reliability of the biometric comparison may be increased significantly. This is because the biometric comparison is not between N number of users (N corresponding to all the users registered in the identification server) but between n number of users (n corresponding to the shortlist of users in communication range with the authorisation module). Thus, the accuracy of the match probability increases as the value of n decreases.

In some examples, the communication channel may be established between a user device and the authorisation module. For example, the user device may be any personal communication device (e.g. mobile phone, tablet, laptop, etc.) with wireless short distance communication capabilities.

In some examples, the identification server may receive the user identifier either from the user device or from the authorisation module. For example, the authorisation module may comprise a wireless beacon (e.g. a Bluetooth beacon) and the user device may identify the beacon. When the beacon is identified, the communication channel may be considered established and the user device may communicate with the identification server that may update the shortlist. Alternatively, the authorisation module may identify the user device identifier (e.g. Bluetooth or Media Access Control (MAC) local area network (LAN) identifier) and notify accordingly the identification module.

In some examples, generating a shortlist of users may comprise identifying a plurality of user identifiers in communication range to the authorisation module and generating a shortlist of user identifiers from the plurality of user identifiers identified. Accordingly, the shortlist may be continuously updated by adding and removing users based on the existence of such communication channel between the user and the authorisation module. Thus, when a user is not in communication range (e.g. after a predetermined period of time) he/she may be removed from the shortlist.

In some examples, registering a user identifier may comprise writing the user identifier and biometric features of the user in a global database of the identification server. Such global database may comprise all the users registered with the system.

In some examples, registering a user identifier may comprise registering a user device identifier. In other examples, registering a user identifier may comprise registering a user identification text string of the user. Then, during identification, the user may manually input (e.g. type, key in or write) her/his identification text at the authorisation module (e.g. using the screen of a tablet). Alternatively, a voice sample of the user may be captured and converted to text. In both cases, the text may be compared to the registered text strings for identification.

In some examples, registering a user identifier may comprise registering a biometric feature of the user. Then, during identification, a biometric feature of the user may be captured. The biometric feature captured may be compared to the registered biometric features for identification.

In some examples, registering one or more biometric features of the user in an identification server may comprise capturing one or more biometric features of the user.

In some examples, capturing the one or more biometric features of the user at an authorisation module may comprise (physically) approaching the authorisation module and capturing the one or more biometric features at a capturing module of the authorisation module.

In some examples, capturing one or more biometric features of the user comprises capturing one or more of an image, an audio, a video, a biological, or a chemical sample of the user. The capture process may be referred to the registration process or to the capture process performed at the authorisation module.

In some examples, capturing an image may comprise capturing an image with one or more of a portion of a face, of a palm, of a fingerprint, of an eye, of ears, of a nose, of teeth, of a tongue, of palm veins pattern, or of finger veins pattern, of the user.

In some examples, capturing an audio may comprise capturing a voice sample of the user.

In some examples, capturing a biological sample may comprise capturing a genetic fingerprint of the user.

In some examples, capturing a chemical sample comprises capturing an odour sample or a sweat sample of the user.

In some examples, capturing the one or more biometric features of the user may comprise automatically capturing the one or more biometric features of the user.

In some examples, the method of performing a user authorisation may further comprise using proof-of-life and/or anti-spoofing techniques during capturing the one or more biometric features of the user.

In some examples, validating the user by comparing the one or more biometric features captured with biometric features stored in the identification server may comprise comparing the one or more biometric features captured with biometric features of the users identified from the generated shortlist of user identifiers.

In some examples, the method of performing a user authorisation may comprise performing a payment, e.g. a predetermined payment, to a vendor. This may be useful when a fixed amount is to be charged to an account of the user. Thus biometric user authorisation may be sufficient for the subsequent charging of the predetermined amount to the account of the user. Alternatively, the payment may be calculated automatically by capturing one or more of an image, a video, a biological, or a chemical sample of a product at a capturing module of the authorisation module.

In some examples, the method of performing a user authorisation may comprise performing a user access authorisation.

In some examples, performing the user authorisation when the user is identified and validated may comprise automatically authorizing a transaction by accessing a credit account, a credit card account or a bank account of the user.

In some examples, performing the user authorisation may comprise automatically identifying a transaction amount. For example, the user may be presented with the transaction amount in e.g. a monitor and may approach the capturing module as an indication of approval of the indicated amount in the monitor.

In some examples, the method may further comprise automatically switching on a transceiver of the personal device to open a communication channel between the user device and the authorisation module. This may be performed based on usage or statistical patterns, e.g. time of day the user visits the vendor. For example, the user device may store a software application that records the biometric authorisation times or the communication channel establishments and based on the statistical usage may automatically open the wireless transceivers before an estimated communication channel establishment.

In some examples, the method of performing a user authorisation may further comprise maintaining a statistical shortlist of a selection of users previously validated in a statistical database. For example, apart from the global database, an intermediate database may be maintained and may form the basis for the shortlist. Thus the authorisation module may not need to access the global database every time but may first access the statistical database to verify that a user has previously used the biometric user authorisation system adding further certainty as to the identification of the particular user.

In another aspect, a system for performing a user authorisation using biometric features is disclosed. The system may comprise an identification server to register a user identifier and one or more biometric features of the user; an authorisation module to establish a communication channel with the user and to capture the one or more biometric features of the user; a filtered database to store a shortlist of user identifiers and corresponding biometric features generated based on users in communication range with the authorisation module, wherein the identification server is configured to compare the one or more biometric features captured with biometric features stored in the filtered database to generate a match probability and validate the user if the match probability exceeds a threshold; and a user authorisation module to automatically perform the user authorisation when the user is identified and validated.

In some examples the identification server may comprise a biometric features comparator. In other examples the identification server may be connected to the biometric features comparator.

In some examples the authorisation module may comprise a capturing module to capture the one or more biometric features of the user. In other examples the authorisation module may be connected to a capturing module. The capturing module may comprise one or more of an image, an audio, a video, a biological, or a chemical capturing module.

In some examples, the authorisation module comprises a wireless interface to establish a communication channel with the user. The authorisation module may comprise a wireless interface to establish a communication channel with a user device of the user. The wireless interface may comprise one or more of a Bluetooth, a WiFi or an ultrasound module. In other examples the wireless interface may comprise a Bluetooth Low Energy beacon. The wireless interface may comprise a plurality of wireless modules distributes in an area of interest.

In yet another aspect, a non-transitory computer program product that causes a processor to perform user authorisation is disclosed. The non-transitory computer program product may have instructions to register a user identifier and one or more biometric features of the user in an identification server; identify the user by the user identifier, the user being in communication range with an authorisation module; generate a shortlist of users based on user identifiers identified; capture the one or more biometric features of the user at the authorisation module; compare the one or more biometric features presented with biometric features stored in the identification server to generate a match probability; validate the user if the match probability exceeds a threshold; and perform the user authorisation when the user is identified and validated.

In yet another aspect a computer program product is disclosed. The computer program product may comprise program instructions for causing a computing system to perform a method according to examples disclosed herein.

The computer program product may be embodied on a storage medium (for example, a CD-ROM, a DVD, a USB drive, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the processes. The carrier may be any entity or device capable of carrying the computer program.

For example, the carrier may comprise a storage medium, such as a ROM, for example a CD ROM or a semiconductor ROM, or a magnetic recording medium, for example a hard disk. Furthermore, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or another device or means.

Alternatively, the carrier may be an integrated circuit in which the computer program is embedded, the integrated circuit being adapted for performing, or for use in the performance of, the relevant methods.

In yet another aspect, a computing device is disclosed. The device may comprise a memory and a processor. The memory may store computer program instructions executable by the processor. Said instructions may comprise functionality to execute a method of biometric user authorisation according to examples disclosed herein.

### DESCRIPTION OF THE DRAWINGS

Non-limiting examples of the present disclosure will be described in the following, with reference to the appended drawings, in which:

FIG. 1 is a flow chart of a biometric user authorisation process, according to an example;

FIG. 2 is a biometric user authorisation configuration, according to an example;

FIG. 3 is a biometric user authorisation configuration, according to another example;

FIG. 4 is a biometric user authorisation configuration, according to another example;

FIG. 5 is a biometric user authorisation configuration, according to another example.

### DETAILED DESCRIPTION OF EXAMPLES

Within the field of biometrics, two types of problems are usually distinguished:
Biometric (e.g. facial) verification, in which given two biometric features, the objective is to decide whether or not they belong to the same person (1:1).
Biometric identification, in which given a gallery of people's biometric features (e.g. faces), and an objective biometric feature, it is about identifying with which of the biometric features (e.g. faces) of the gallery the objective biometric feature corresponds (1:N)

Biometric identification systems have a performance that decreases as the size of the gallery increases, that is, the greater the number of biometric features registered, the more likely it is to find an incorrect correspondence.

The state of the art of the biometric identification does not allow, in a sufficiently secure way for transactions, to carry out the identification. Therefore, the problem has been reduced to a smaller environment wherein the identification process may achieve high accuracy, for which the use of a filtered shortlist of users is proposed. The filtered shortlist may be generated by using a user identifier. Such user identifier may be unique or may belong to a subset of users. The user identifier may be in the form of a user device identifier, a text string or a biometric feature of the user. The user identifier may be stored in the global database along with other identifiers and/or biometric features of the user. Thus, when a user identifier is presented/identified, a filtered shortlist may be generated or updated by including the user(s) data that correspond to the user identifier identified.

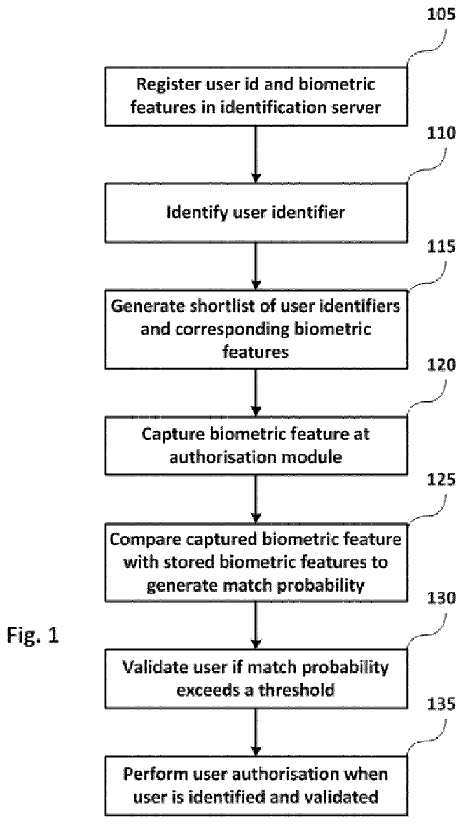

FIG. 1 is a flow chart of a biometric authorisation process, according to an example. In block 105, a user identifier and one or more biometric features of the user are registered in an identification server. In block 110, the user is identified by the user identifier. The user may be in communication range with an authorisation module. In block 115, a shortlist of users is generated based on identified user identifiers. In block 120, the one or more biometric features of the user are captured at the authorisation module. In block 125, the captured biometric features of the user may be compared with biometric features stored in the identification server to generate a match probability. In block 130, the user may be validated if the match probability exceeds a predetermined threshold. In block 135, the user authorisation is performed when the user is identified and validated.

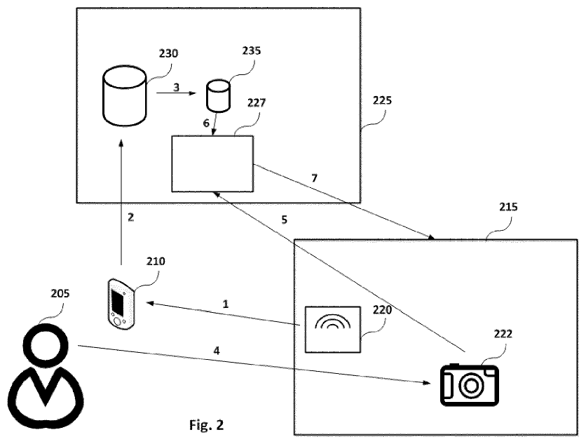

FIG. 2 schematically illustrates a biometric user authorisation use case using a user device. A user 205 carrying a user device 210 may initially be outside communication range from authorisation module 215. For example, the user device may comprise a Bluetooth Low Energy (BLE) transceiver with only a few meters of communication range. The authorisation module 215 may comprise a wireless emitter, e.g. BLE beacon emitter 220. When the user device 210 is in communication range with the beacon emitter 220, a communication channel may be established and the user device 210 may detect the signal from the beacon emitter 220. When this happens, the user device 210 may transmit the user device identifier to identification server 225. The identification server 225 may receive the user device identifier, retrieve the biometric data corresponding to the user device identifier from the global database 230 and write or copy the user device identifier and the corresponding biometric features to the filtered or “reduced” database 235. Then the user may approach a capturing module 222 of the authorisation module 215. The capturing module 222 may capture one or more biometric features of the user 205. The authorisation module 215 may then send the captured biometric features to the identification server 225. The identification server 225 may comprise a biometric features comparator 227, e.g. in the form of an electronic/computer processing/software module. The biometric features comparator 227 may compare the received biometric features with the ones stored in the filtered or reduced database 235 to generate a match probability. Then the biometric features comparator 227 may validate the user if the match probability exceeds a threshold and thus grant user authorisation. Upon receiving the validation, the authorisation module 215 may then proceed with e.g. performing a transaction or with granting access to the user to a specified location.

The capturing module 222 may be any type of electronic equipment with functionality to capture biometric features. For example, the capturing module 222 may be an image capturing device (e.g. a camera, video-camera, etc.), a voice recording device (e.g. microphone) or a fingerprint sensor. It may also be any type of communication or electronic device with capturing functionalities (e.g. a mobile phone, a tablet, laptop or desktop computer with integrated microphone and/or camera etc.). The biometric features captured may be any physical characteristic containing a biometric feature. For example, it may be any of (or a combination of) a facial characteristic, a palm characteristic (e.g. a fingerprint), a vocal characteristic, or any other physical characteristic containing a biometric feature. The biometric features comparator 227 may receive a digital representation of the biometric feature captured (e.g. in the form of a file).

The biometric features comparator 227 may be running on the same device as the identification server 215 or it may reside in an external or remote server or in a cloud server. The capturing module 222 may be connected directly or wirelessly with the biometric features comparator 227.

Security measures may be in place to assure that both the registration and the authorisation processes are properly held by a legit user and no attacks to the system or unwanted accesses happen. Under such situations, measures to counter spoofing attacks such as anti-spoofing systems or proof-of-life systems are optional (but recommended) to be added to the registration/authorisation system.

The combination of biometric-facial factors with complementary ones, in this case, the unique identification of the user's mobile device provides a high level of reliability. The combination of a selfie-type photo with the identification of the device, is relatively easy to implement, easy to perform by the user, with safe and fast execution. It allows a user to enter it as a double security factor: “something you are” (the face), “something you have” (your mobile). In addition, it does not imply any type of manual action. For example, if the user is carrying a tray, e.g. in a restaurant, the user would not have to leave the tray to perform any transaction required.

The process may be divided into two clearly different stages: Registration and authorisation (e.g. payment). In the first stage, the user must register in a system capable of registering his data so that, when making the payment, he can be identified unequivocally.

Once the registration is made, the user may make the transaction by taking a selfie-type photo at the authorisation module, with his mobile in his bag/pocket, comparing this information in the identification server and automatically performing the payment in case of success.

The user may downloads a mobile application (APP) on his user device and put it into operation. Then, the APP may request the necessary data to carry out the registration. The APP may read the unique identifier of the device and send it to the identification server 225.

On the other hand, the APP may get an image of the person's face by automatic capture. This photo may be sent to the identification server 225 that may store in the global database 230 the photograph of the user together with the user device identifier.

The payment experience may be based on a biometric customer identification procedure that is complemented with the identification of the user device as a second factor. The detection of the user device may be done using Bluetooth technology that allows activating the client's APP when the user device is in communication range with the payment point (acting as an authorisation module).

To achieve this, it may be necessary to have activated the Bluetooth of the mobile device. To prevent the user from having Bluetooth activated permanently, the app may activate the Bluetooth of the mobile device for example every day at 1:00 PM, from Monday to Friday, (if it was turned off) without the user having to do any type of action or the user may be notified to activate the Bluetooth if it was not turned on during similar days and times.

In one example, the payment point may be located at the end of a special queue for biometric payment. At that point one (or several) payment post(s) may be located, which may consist of a screen, a camera, a system emitting Bluetooth beacons and software for payment management.

Thus, when the user approaches the payment point, the APP may be able to detect it by identifying a special low energy Bluetooth beacon emitted by the payment point itself.

When the user is close enough to the payment point, the mobile APP may send the device's identifier to the identification server to add it to the filtered database. This procedure may allow the identification server to reduce the number of possible faces against which the subsequent biometric comparison can be made.

The APP may be actively listening to the presence of the beacon corresponding to the payment point. It is important to note that Bluetooth technology works in situations where the mobile device is inside a pocket, a purse or a backpack. This implies that the process of identification of the person's device does not require any type of user action at the payment terminal.

In front of the payment point, the screen may indicate a message asking the user to place his face in front of the camera to take a picture. The payment point may be provided with a photo capture software and automatic triggering. To avoid taking pictures of faces that accidentally look at the camera, the software may have mechanisms that ensure that the person looking at the camera is at the right distance and watching for a controlled time without interruption (e.g. 2-3 seconds).

After capture, the system may proceed to send said photo to the identification server 225. In this way, the facial biometric engine may obtain a result of the comparison between the face just sent to the server and the faces of the people who are in the filtered database 235. The elements present in the filtered database 235 are the user device identifiers that have been added by listening to the beacon of the payment point and corresponding biometric features retrieved from the global database 230. A usual use case may be that the filtered database contains data from a handful of users, e.g. between 2 and 4 users (those who are currently in line near the payment point).

If the comparison procedure does not return a sufficiently high match probability by the biometric features comparator 227, the payment point may be notified to show on screen that the process could not be completed. The user will be offered the possibility to repeat the photo capture or any other action, such as the assistance of a worker.

If the comparison procedure has been successful, two actions may be carried out:
The person who has just completed the biometric comparison may be removed from the filtered database.
The payment point may be notified that the comparison is correct so that the customer can leave the queue.

The identification server 225 may be able to eliminate elements of the filtered database in two other cases: when the user's face takes too much time in the database; or when the user device indicates that the user is not in communication range with the Bluetooth beacon 220.

The last stages of the process may be the realization of the payment and the notification to the user that his payment has been completed. Additionally, an intelligent management of the Bluetooth emitter may be carried out upon receiving the notification, by automatically turning it off without the user being aware of it or by reminding the users that they can turn it off if they wish.

An alternative to the use of Bluetooth to filter the number of faces to be used is the use of a known technique of ultrasonic modulation. In this case, an ultrasonic emitter (e.g. loudspeakers) may be placed at the authorisation module 215, which may emit signals in the range of ultrasound (not audible).

Nearby user devices that carry the APP installed (with a microphone in listening mode), may wake up, in that case sending their user device identifier to the identification server 225, to perform the whole operation of filtering faces in the same way as in the case of Bluetooth.

In another implementation, the authorisation module may comprise a plurality of emitters 220 distributed in an area of interest. In order for a user identifier to be included in the filtered database, the user device 210 may be required to be in communication range with a minimum number or with all of the emitters 220. This may allow to more precisely define the area of interest where a user may be located in order to be included in the filtered database. For example, the emitters 220 may be positioned in a restaurant area around a tray area so that an intersection of the emitted signals to include the notional line followed by a person being in line.

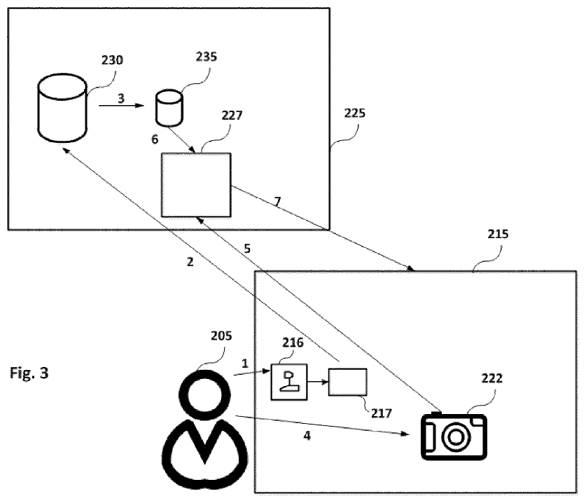

FIG. 3 schematically illustrates an alternative biometric user authorisation use case. A user 205 may initially be outside communication range from authorisation module 215. By communication range in this use case it is envisaged the possibility to recognise the voice of the user by authorisation module 215. For example, the authorisation module 215 may comprise a microphone 216. When the user 205 is in communication range with the microphone 216, the user may pronounce a phrase. The authorisation module 215 may comprise a speech-to-text conversion module 217 to convert the pronounced phrase to a text string. When this happens, the authorisation module 215 may transmit the text string, as a user identifier, to the identification server 225. For example, the user could use his telephone number (or a part of the telephone number) as user identifier. In this case, the user may pronounce his telephone number and the speech-to-text conversion module 217 may convert the pronounced telephone number to a text string. Alternatively, the user may key in the text string, e.g. telephone number, assuming that he/she has not yet picked up the tray. The identification server 225 may receive the user identifier, retrieve the biometric data corresponding to the user identifier from the global database 230 and write or copy the user identifier and the corresponding biometric features to the filtered or “reduced” database 235. In the case of telephone number, the global database 230 may store telephone numbers as user identifiers. During the registration process, the telephone number could be read automatically by the user device and sent to the identification server 225. Then the user may approach a capturing module 222 of the authorisation module 215. The capturing module 222 may capture one or more biometric features of the user 205. The authorisation module 215 may then send the captured biometric features to the identification server 225. The identification server 225 may comprise a biometric features comparator 227. The biometric features comparator 227 may compare the received biometric features with the ones stored in the filtered or reduced database 235 to generate a match probability. Then, the biometric features comparator 227 may validate the user if the match probability exceeds a threshold and thus grant user authorisation. Upon receiving the validation, the authorisation module 215 may then proceed with e.g. performing a transaction or with granting access to the user to a specified location.

In an example implementation, the area of interest may be a business which prepares and serves food and drinks to customers in exchange for money, e.g. a restaurant. In some cases, the price of the meal or menu may be predetermined or fixed and therefore a user authorisation, according to examples disclosed herein, may automatically imply a transaction at the predetermined value. However, in other cases the price may not be fixed. For example, a user may fill in a tray with various items or plates present in a buffet type area. Then the user may approach the capturing module 222 with the tray. The capturing module 222 may capture an image of the user for authorisation purposes and may also capture an image of the tray for price calculation purposes. The image of the tray may be automatically analysed to identify objects on the tray so that the authorisation module 215 may automatically calculate the total price of the items or plates present on the tray. The total price with a list of the items present on the tray may then be presented to the user in a monitor. The photo of the tray may be captured before the photo of the user so that the user may implicitly accept and authorise the transaction by approaching the capturing module to have his/her photo taken.

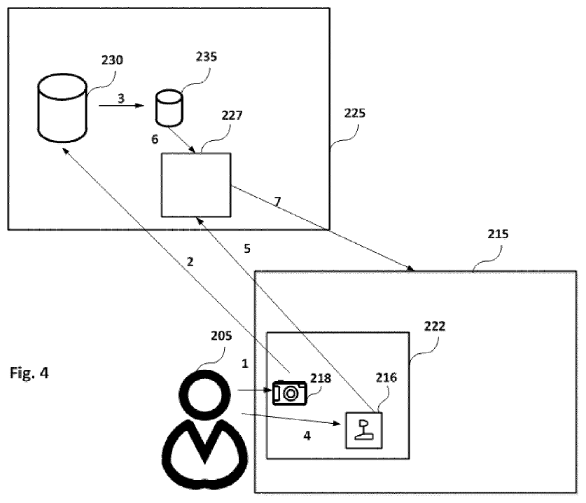

FIG. 4 schematically illustrates an alternative biometric user authorisation use case. A user 205 may initially be outside communication range from authorisation module 215. By communication range in this use case it is envisaged the possibility to recognise a biometric feature of the user by authorisation module 215. For example, the authorisation module 215 may comprise a capturing module 222 with two biometric capturing elements e.g. a microphone 216 and a camera 218. When the user 205 is in communication range with the microphone 216 or the camera 218, the user may pronounce a phrase or the camera 218 may capture a photo of the user. In one example the camera 218 may first capture a photo. When this happens, the authorisation module 215 may transmit the biometric feature retrieved by the photo, as a user identifier, to the identification server 225. The identification server 225 may receive the biometric feature as a user identifier, and may retrieve the biometric data from the global database corresponding to a subset of users that have similar biometric features (e.g. users whose image biometric feature has a degree of similarity above a threshold) and write or copy the user identifier (first biometric feature) and the corresponding (rest of) biometric features to the filtered or “reduced” database 235. Thus the identification server may generate a shortlist of users with similar image characteristics. Then the user may approach the microphone 216 of the authorisation module 215. The microphone 216 may capture a vocal biometric feature of the user 205, e.g. a pronounced phrase. The authorisation module 215 may then send the second captured biometric feature to the identification server 225. The identification server 225 may comprise a biometric features comparator 227. The biometric features comparator 227 may compare the received biometric feature with the ones stored in the filtered or reduced database 235 to generate a match probability. Then, the biometric features comparator 227 may validate the user if the match probability exceeds a threshold and thus grant user authorisation. Upon receiving the validation, the authorisation module 215 may then proceed with e.g. performing a transaction or with granting access to the user to a specified location.

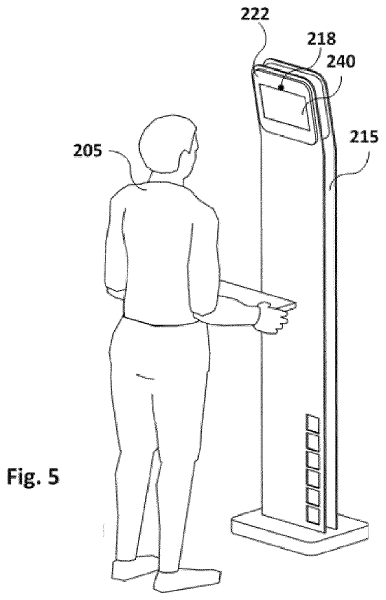

FIG. 5 schematically illustrates a use case. A user 205 may approach an authorisation module 215. In the example of FIG. 5 the authorisation module is in the form of a totem. The authorisation module may comprise a capturing module 222 (with a microphone to capture e.g. a voice sample and/or a camera 218 to capture an image of the user and/or of the tray). The totem may further comprise a monitor 240 to indicate the correct performance of the system to the user (e.g. identification process, validation process, authorisation process). As shown in FIG. 5, the user may not need to remove his hands from the tray at any moment in order to perform any identification or authorisation steps.

It is important to consider that these use cases descriptions only cover the authorisation system steps needed to gather and process the biometric information in order to assess the biometric authorisation. Thus, all security concerns in terms of how the system ensures a safe registration/authorisation are not described here.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

Furthermore, although the examples described with reference to the drawings comprise computing apparatus/systems and processes performed in computing apparatus/systems, the invention also extends to computer programs, particularly computer programs on or in a carrier, adapted for putting the system and method into practice.

1. A method of performing a user authorisation of a user using biometric features, comprising:
registering a user identifier and one or more biometric features of the user in an identification server;
identifying the user by the user identifier, the user being in communication range with an authorisation module;
generating a shortlist of users based on user identifiers identified;
capturing the one or more biometric features of the user at the authorisation module;
comparing the one or more biometric features presented with biometric features stored in the identification server to generate a match probability;
validating the user if the match probability exceeds a threshold;
performing the user authorisation when the user is identified and validated.

2. The method of performing a user authorisation according to claim 1, wherein identifying the user comprises establishing a communication channel between the user and the authorisation module.

3. The method of performing a user authorisation according to claim 2, wherein the communication channel is established between a user device and the authorisation module.

4. The method of performing a user authorisation according to claim 1, wherein identifying the user comprises communicating the user identifier to the identification server either from the user device or from the authorisation module.

5. The method of performing a user authorisation claim 1, wherein generating a shortlist of users comprises:
identifying a plurality of user identifiers in communication range to the authorisation module; and
generating a filtered database from the plurality of identified user identifiers and corresponding biometric features.

6. (canceled)

7. The method of performing a user authorisation according claim 1, wherein registering a user identifier comprises registering a user device identifier.

8. The method of performing a user authorisation according to claim 1, wherein registering a user identifier comprises registering a user identification text string of the user.

9. The method of performing a user authorisation according to claim 8, wherein identifying the user identifier comprises manually inputting the user identifier at the authorisation module and comparing the text input to the registered text strings.

10. (canceled)

11. The method of performing a user authorisation according to claim 1, wherein registering a user identifier comprises registering a biometric feature of the user.

12. The method of performing a user authorisation according to claim 11, wherein identifying the user identifier comprises capturing a biometric feature of the user and comparing the biometric feature captured to the registered biometric features.

13. The method of performing a user authorisation according to claim 1 wherein registering one or more biometric features of the user in an identification server comprises capturing one or more biometric features of the user including capturing one or more of an image, an audio, a video, a biological, or a chemical sample of the user.

14. The method of performing a user authorisation according to claim 1, wherein capturing the one or more biometric features of the user at an authorisation module comprises approaching the authorisation module and capturing the one or more biometric features at a capturing module of the authorisation module, said capturing of the one or more biometric features of the user including capturing one or more of an image, an audio, a video, a biological, or a chemical sample of the user.

15-19. (canceled)

20. The method of performing a user authorisation according to claim 1, wherein capturing the one or more biometric features of the user comprises automatically capturing the one or more biometric features of the user.

21. (canceled)

22. The method of performing a user authorisation according to claim 1, wherein comparing the one or more biometric features captured with biometric features stored in the identification server comprises comparing the one or more biometric features captured with biometric features of the users identified from the generated shortlist of user identifiers.

23. The method of performing a user authorisation according to claim 1, comprising performing a payment to a vendor.

24. The method of performing a user authorisation according to claim 23, comprising performing a predetermined payment to the vendor.

25. The method of performing a user authorisation according to claim 23, wherein performing a payment to a vendor comprises;
capturing one or more of an image, a video, a biological, or a chemical sample of a product at a capturing module of the authorisation module;
calculating automatically the prize of the product.

26. The method of performing a user authorisation according to claim 1, comprising performing a user access authorisation.

27-28. (canceled)

29. The method of performing a user authorisation according to claim 3, further comprising automatically switching on a transceiver of the personal device to open a communication channel between the user device and the authorisation module.

30. The method of performing a user authorisation according to claim 1, further comprising maintaining a statistical shortlist of a selection of users previously validated in a statistical database.

31-43. (canceled)
